(19) United States
(12) Patent Application Publication
(10) Pub. No.: US 2013/0084385 A1
(43) Pub. Date: Apr. 4, 2013

(54) METHOD FOR PRODUCING CORE-SHELL MAGNETIC ALLOY NANOPARTICLE

(71) Applicants: Mingjie Zhou, Shenzhen (CN); Shuxin Lu, Shenzhen (CN); Wenbo Ma, Shenzhen (CN)

(72) Inventors: Mingjie Zhou, Shenzhen (CN); Shuxin Lu, Shenzhen (CN); Wenbo Ma, Shenzhen (CN)

(21) Appl. No.: 13/703,311

(22) PCT Filed: Jun. 13, 2010
(86) PCT No.: PCT/CN10/73945

§ 371 Date: Dec. 10, 2012

(51) Int. Cl. H01F 41/00

(52) U.S. Cl. CPC H01F 41/00
USPC 427/127

(57) ABSTRACT

A method for producing core-shell magnetic alloy nanoparticle, comprising: step 1, dissolving nickel compound to produce solution; step 2, adding surfactant into the solution; step 3, dissolving the first reducing agent to produce the first reducing solution; step 4, adding the first reducing solution into the solution obtained from step 2, obtaining nickel nano-collosol by stirring and aging; step 5, adding metallic compound into the nickel nano-collosol; step 6, dissolving the second reducing agent to produce the second reducing solution; step 7, adding the second reducing solution into the mixed solution obtained from step 5; step 8, allow the product to stand, then discarding the supernatant, redispersing in water or absolute ethyl alcohol to obtain the core-shell magnetic alloy nanoparticle using nickel as the core.

### FIELD OF THE INVENTION

The present invention relates to a method for producing alloy metal nanoparticle. More particularly, the invention relates to a method for producing core-shell magnetic alloy nanoparticle.

### BACKGROUND OF THE INVENTION

Usually, the magnetic nanocomposite particles have two structures: one is to take magnetic nanoparticles as the core, a certain functional material as the shell; the other opposite structure is to take magnetic nanoparticles as the shell, a certain functional material as the core. Such composite structures not only retain the special magnetic properties of magnetic nanoparticles, but also enhance the biocompatibility, thermal stability, mechanical stability and chemical stability of magnetic nanoparticles, obtaining a series of new performance. For example, silica microspheres embedding magnetic nanoparticles and quantum dots have the performance of magnetic nanoparticles, quantum dots and silica.

It is extremely difficult for pure nickel magnetic metal nanoparticles to be put into use. Because the nickel nanoparticles are easily oxidized under oxygen environment, and its application has been greatly limited. The noble metal nanoparticles have good thermal conductivity and electrical conductivity, they are corrosion resistant and antioxidant, even at the nanoscopic scale. Therefore, to coat the magnetic metal nanoparticles on the surface with noble metals can retain the magnetic characteristics of magnetic metal nanoparticles. On this basis, the oxidation rate can be effectively slowed down and chemical stability can be improved. In addition, it provides a multifunctional platform at the nanoscopic scale by coating magnetic metal nanoparticles with gold, silver or other noble metals. For example, gold can be combined with a variety of antibodies, nucleic acids, enzymes, proteins and other biological molecules by making use of gold biocompatibility and strong adsorption capacity on amino groups or thiol groups, thereby preparing magnetic biomedical materials, and it has broad application prospects in the field of immunoassay, biological separation and others.

### SUMMARY OF THE INVENTION

The technical problem of the present invention to be solved is to provide a method for producing core-shell magnetic alloy metal nanoparticle, which is simple and low demand on equipment and low-cost.

The technical solution to solve the technical problem of the present invention is: to provide a method for producing core-shell magnetic alloy nanoparticle, comprising:

step 1: dissolving nickel compound in solvent to produce solution, said solution is in the range of 1×10⁻¹ mol/L to 1×10⁻⁴ mol/L;

step 2: adding surfactant into the solution obtained from step 1, the molar ratio of surfactant to nickel ion is in the range of 0.3:1 to 20:1;

step 3: dissolving the first reducing agent in solvent to produce the first reducing solution;

step 4: pipetting the first reducing solution obtained from step 3 according to the molar ratio of the first reducing agent to nickel ion, which is in the range of 2.5:1 to 4:1, and adding into the solution obtained from step 2 with stirring, continue to stir and react for 5 to 30 min, then aging for 3 to 24 h to obtain nickel nano-collosol;

step 5: adding metallic compound into the nickel nano-collosol obtained from step 4 to make the concentration of metallic compound in nickel nano-collosol in the range of 1×10⁻² mol/L to 1×10⁻⁵ mol/L, stirring at room temperature for 20 to 60 min;

step 6: dissolving the second reducing agent in solvent to produce the second reducing solution;

step 7: pipetting the second reducing solution obtained from step 6 according to the molar ratio of the second reducing agent to metallic compound obtained from step 5, which is in the range of 2:1 to 8:1, and adding into the mixed solution obtained from step 5;

step 8: allow the reaction product obtained from step 7 to stand, then discarding the supernatant, redispersing the obtained precipitate in water or absolute ethanol to obtain the core-shell magnetic alloy nanoparticle using nickel as the core.

In the present invention, in said step 1, said nickel compound is nickel chloride, nickel nitrate or nickel sulfate; said solvent is water, ethanol or glycol. In said step 2, said surfactant is sodium citrate, polyvinylpyrrolidone, cetyl trimethyl ammonium bromide or sodium dodecyl sulfate. In said step 3, said the first reducing agent is potassium borohydride or sodium borohydride; said solvent is water or ethanol, the concentration of the first reducing agent is in the range of 5×10⁻¹ mol/L to 1×10⁻³ mol/L. In said step 4, said aging is carried out at room temperature and in a sealed condition. In said step 5, said metallic compound is silver nitrate, chloroauric acid, palladium chloride or chloroplatinic acid. In said step 6, said the second reducing agent is ascorbic acid, potassium borohydride or sodium borohydride; said solvent is water or ethanol, the concentrate of the second reducing agent is in the range of 1×10⁻¹ mol/L to 1×10⁻³ mol/L. In said step 7, during the process of adding the second reducing solution into the mixed solution obtained from step 5, magnetically stirring the mixed solution obtained from step 5; after adding the second reducing solution into the mixed solution obtained from step 5, continue to stir and react for 5 to 60 min. In said step 8, allow the reaction product obtained from step 7 to stand in the magnetic field for 0.5 to 5 h.

In the method for producing core-shell magnetic alloy metal nanoparticle of the present invention, the core-shell metal particles are producing by two-step method comprising: firstly, to make the nickel core; secondly, to make metal shell on the surface of the core. Making the nickel core first can control particle size of the core through adjusting the concentration of nickel. Meanwhile, making the metal shell separately can control the thickness of shell by adjusting the ratio of nickel and metal. Also, the process is simple, low demand on equipment and low-cost.

### BRIEF DESCRIPTION OF THE DRAWINGS

Further description of the present invention will be illustrated, which combined with embodiments in the drawings:

FIG. 1 is a flow chart of the method for producing fluorescent material used in field emission of the present invention.

FIG. 2 is an ultraviolet-visible spectrum of nickel nanoparticle produced by the producing method of Example 1.

FIG. 3 is an ultraviolet-visible spectrum of silver nanoparticle produced by using the producing method of Example 1.

FIG. 4 is an ultraviolet-visible spectrum of nickel@silver nanoparticle produced by using the producing method of Example 1.

### DETAILED DESCRIPTION OF ILLUSTRATED EMBODIMENTS

Further description of the present invention will be illustrated, which combined with embodiments in the drawings, in order to make the purpose, the technical solution and the advantages clearer. While the present invention has been described with reference to particular embodiments, it will be understood that the embodiments are illustrative and that the invention scope is not so limited.

The present invention provides a core-shell magnetic alloy nanoparticle having the chemical formula of Ni@M, where Ni is the core, @ stands for coating, M is the shell coating the core, M is Ag, Au, Pt or Pd.

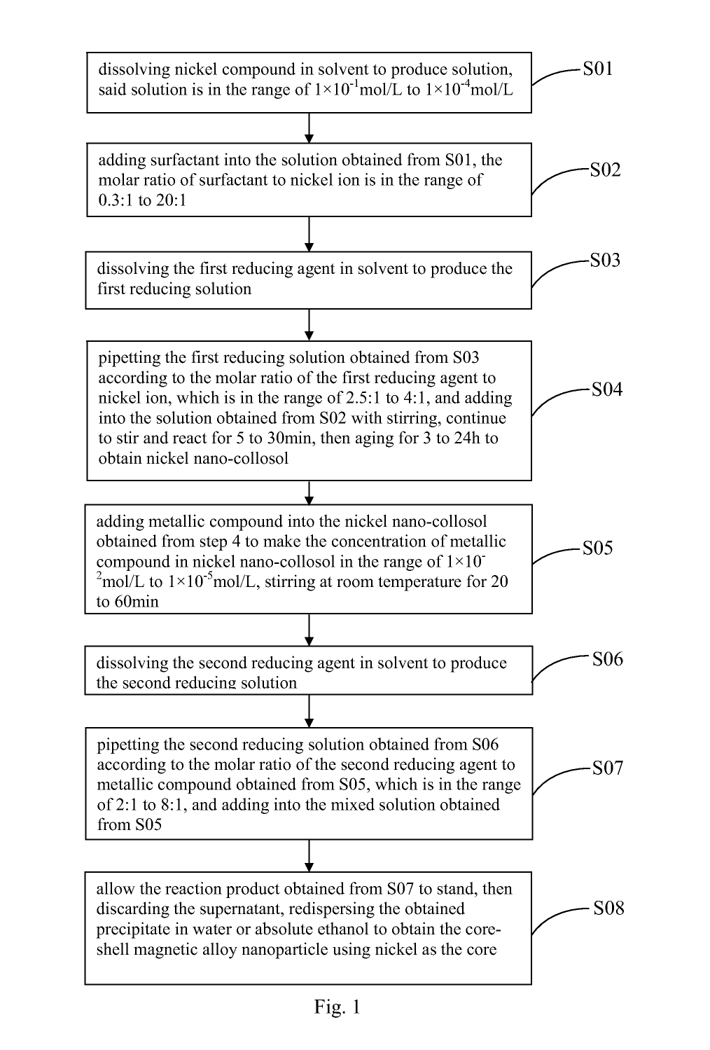

Referring to FIG. 1, FIG. 1 shows a flow chart of the method for producing core-shell magnetic alloy nanoparticle of the present invention, comprising:

S01: dissolving nickel compound in solvent to produce solution, said solution is in the range of 1×10⁻¹ mol/L to 1×10⁻⁴ mol/L;

S02: adding surfactant into the solution obtained from SOL the molar ratio of surfactant to nickel ion is in the range of 0.3:1 to 20:1;

S03: dissolving the first reducing agent in solvent to produce 5×10⁻¹ mol/L to 1×10⁻³ mol/L of the second reducing solution;

S04: pipetting the first reducing solution obtained from S03 according to the molar ratio of the first reducing agent to nickel ion, which is in the range of 2.5:1 to 4:1, and adding into the solution obtained from S02 with stirring, continue to stir and react for 5 to 30 min, then aging for 3 to 24 h to obtain nickel nano-collosol;

S05: adding metallic compound into the nickel nano-collosol obtained from step 4 to make the concentration of metallic compound in nickel nano-collosol in the range of 1×10⁻² mol/L to 1×10⁻⁵ mol/L, stirring at room temperature for 20 to 60 min;

S06: dissolving the second reducing agent in solvent to produce 1×10⁻¹ mol/L to 1×10⁻³ mol/L of the second reducing solution;

S07: pipetting the second reducing solution obtained from S06 according to the molar ratio of the second reducing agent to metallic compound obtained from S05, which is in the range of 2:1 to 8:1, and adding into the mixed solution obtained from S05;

S08: allow the reaction product obtained from S07 to stand, then discarding the supernatant, redispersing the obtained precipitate in water or absolute ethanol to obtain the core-shell magnetic alloy nanoparticle using nickel as the core.

In the present invention, in said S01 said nickel compound is nickel chloride, nickel nitrate or nickel sulfate; said solvent is water, ethanol or glycol. In said S02, said surfactant is sodium citrate, polyvinylpyrrolidone, cetyl trimethyl ammonium bromide or sodium dodecyl sulfate. In said S03, said the first reducing agent is potassium borohydride or sodium borohydride; said solvent is water or ethanol. In said S04, said aging is carried out at room temperature and in a sealed condition. In said S05, said metallic compound is silver nitrate, chloroauric acid, palladium chloride or chloroplatinic acid. In said S06, said the second reducing agent is ascorbic acid, potassium borohydride or sodium borohydride; said solvent is water or ethanol. In said S07, during the process of adding the second reducing solution into the mixed solution obtained from S05, magnetically stirring the mixed solution obtained from S05; after adding the second reducing solution into the mixed solution obtained from S05, continue to stir and react for 5 to 60 min. In said S08, allow the reaction product obtained from S07 to stand in the magnetic field for 0.5 to 5 h.

In the method for producing core-shell magnetic alloy metal nanoparticle of the present invention, the core-shell metal particles are producing by two-step method comprising: firstly, to make the nickel core; secondly, to make metal shell on the surface of the core. Making the nickel core first can control particle size of the core through adjusting the concentration of nickel. Meanwhile, making the metal shell separately can control the thickness of shell by adjusting the ratio of nickel to metal. Also, the process is simple, low demand on equipment and low-cost.

Special embodiments are disclosed as follows to demonstrate method for producing core-shell magnetic alloy metal nanoparticle and the performances of it.

### EXAMPLE 1

(1) Taking deionized water as solvent, nickel sulfate as solute to make 10.0 mL of aqueous solution of nickel sulfate, the concentration of nickel ion in aqueous solution of nickel sulfate is 1×10⁻² mol/L; under the condition of magnetic stirring, adding 29.4 mg of sodium citrate into aqueous solution of nickel sulfate according to the molar ratio of surfactant to nickel ion which is 1:1, stirring to aid dissolving;

(2) taking deionized water as solvent to make 10 mL of 1×10⁻¹ mol/L sodium borohydride reducing solution;

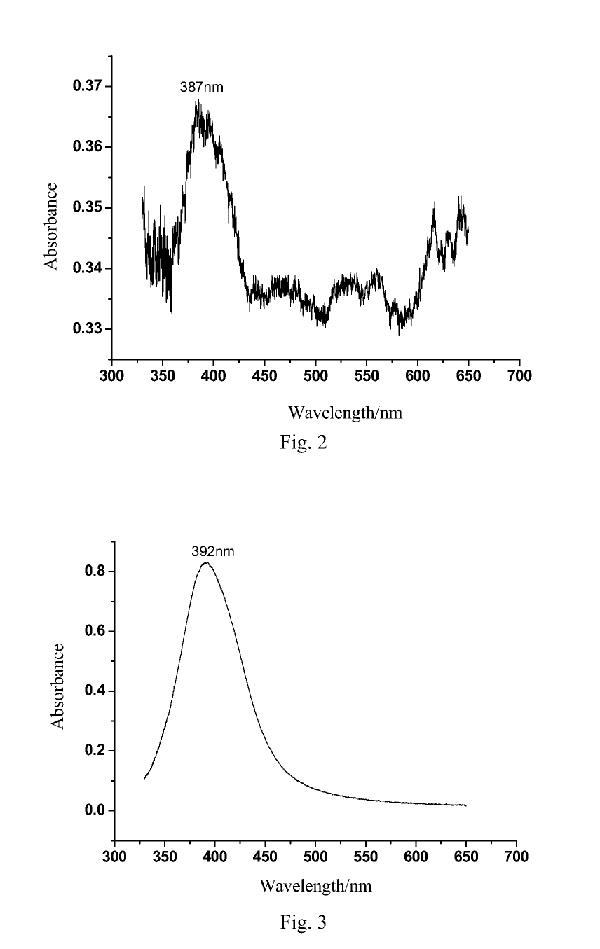

(3) at normal temperature and under the condition of magnetic stirring, rapidly adding 4.0 mL portions of sodium borohydride reducing solution into aqueous solution of nickel sulfate according to the molar ratio of reducing agent to nickel ion, which is 4:1; allow to react for 5 min, then sealing with plastic wrap, at room temperature to aging for 3 h, diluting to 20 mL with deionized water, obtaining 20 mL of nickel nano-collosol containing 5×10⁻² mol/L of nickel. Its absorption spectrum shows in FIG. 2.

(4) adding 3.4 mg of silver nitrate into 20 mL of nickel nano-collosol to make 1×10⁻³ mol/L of silver nitrate in nickel nano-collosol, stirring for 20 min;

(5) taking deionized water as solvent to make 1×10⁻² mol/L aqueous solution of sodium borohydride, then rapidly adding 4 mL portions of aqueous solution of sodium borohydride into the mixed solution obtained in step (4) according to the molar ratio of reducing agent to silver ion which is 2:1, stirring and allow to react for 5 min;

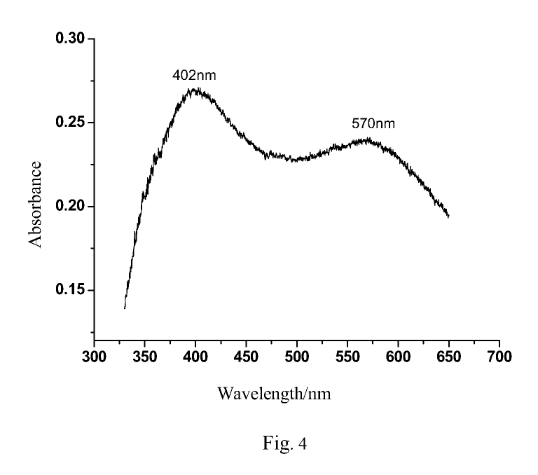

(6) allow the reaction solution obtained in step (5) to stand in the magnetic field for 1.5 h, discarding the supernatant then redispersing the obtained precipitate in deionized water to obtain desired Ni@Ag nanoparticle. Its absorption spectrum shows in FIG. 4.

Referring to the method above: adding 3.4 mg of silver nitrate into 20 mL portions of deionized water to obtain 1×10⁻³ mol/L aqueous solution of silver nitrate, stir for 20 min, then taking deionized water as solvent to make 1×10⁻² mol/L aqueous solution of sodium borohydride, and rapidly adding 4 mL portions of aqueous solution into aqueous solution of silver nitrate according to the molar ratio of reducing agent to silver ion which is 2:1, stirring and allow to react for 5 min to obtain Ag nanoparticle. Its absorption spectrum shows in FIG. 3.

### EXAMPLE 2

(1) Taking absolute ethanol as solvent, nickel chloride as solute to make 10.0 mL of ethanol solution of nickel chloride, the concentration of nickel ion in ethanol solution of nickel chloride is 1×10⁻¹ mol/L; under the condition of magnetic stirring, adding 911.1 mg of cetyl trimethyl ammonium bromide (CTAB) into ethanol solution of nickel chloride according to the molar ratio of surfactant to nickel ion which is 2.5:1, stirring to aid dissolving;

(2) taking absolute ethanol as solvent to make 10 mL of 5×10⁻¹ mol/L potassium borohydride reducing solution;

(3) at normal temperature and under the condition of magnetic stirring, rapidly adding 5.0 mL portions of potassium borohydride reducing solution into ethanol solution of nickel chloride according to the molar ratio of reducing agent to nickel ion, which is 2.5:1; allow to react for 15 min, then sealing with plastic wrap, at room temperature to aging for 12 h, diluting to 20 mL with absolute ethanol, obtaining 20 mL of nickel nano-collosol containing 5×10⁻² mol/L of nickel;

(4) adding 10.4 mg of chloroplatinic acid into 20 mL of nickel nano-collosol to make 1×10⁻³ mol/L of chloroplatinic acid in nickel nano-collosol, stirring for 30 min;

(5) taking absolute ethanol as solvent to make 1×10⁻² mol/L ethanol solution of potassium borohydride, then rapidly adding 8 mL portions of ethanol solution of potassium borohydride into the mixed solution obtained in step (4) according to the molar ratio of reducing agent to silver ion which is 4:1, stirring and allow to react for 40 min;

(6) allow the reaction solution obtained in step (5) to stand in the magnetic field for 0.5 h, discarding the supernatant then redispersing the obtained precipitate in absolute ethanol to obtain desired Ni@Pt nanoparticle.

### EXAMPLE 3

(1) Taking deionized water as solvent, nickel sulfate as solute to make 20.0 mL of aqueous solution of nickel sulfate, the concentration of nickel ion in aqueous solution of nickel sulfate is 1×10⁻³ mol/L; under the condition of magnetic stirring, adding 300 mg of polyvinylpyrrolidone (PVP) into aqueous solution of nickel sulfate according to the molar ratio of surfactant to nickel ion which is 0.3:1, stirring to aid dissolving;

(2) taking deionized water as solvent to make 10 mL of 1×10⁻² mol/L potassium borohydride reducing solution;

(3) at normal temperature and under the condition of magnetic stirring, rapidly adding 6.0 mL portions of potassium borohydride reducing solution into aqueous solution of nickel sulfate according to the molar ratio of reducing agent to nickel ion, which is 3:1; allow to react for 30 min, then sealing with plastic wrap, at room temperature to aging for 3 h, diluting to 40 mL with deionized water, obtaining 40 mL of nickel nano-collosol containing 5×10⁻⁴ mol/L of nickel;

(4) adding 70.9 mg of palladium chloride into 40 mL of nickel nano-collosol to make 1×10⁻² mol/L of palladium chloride in nickel nano-collosol, stirring for 40 min;

(5) taking deionized water as solvent to make 1×10⁻¹ mol/L aqueous solution of potassium borohydride, then rapidly adding 2 mL portions of aqueous solution of potassium borohydride into the mixed solution obtained in step (4) according to the molar ratio of reducing agent to silver ion which is 5:1, stirring and allow to react for 20 min;

(6) allow the reaction solution obtained in step (5) to stand in the magnetic field for 2 h, discarding the supernatant then redispersing the obtained precipitate in deionized water to obtain desired Ni@Pd nanoparticle.

### EXAMPLE 4

(1) Taking deionized water as solvent, nickel nitrate as solute to make 20.0 mL of aqueous solution of nickel nitrate, the concentration of nickel ion in aqueous solution of nickel nitrate is 1×10⁻³ mol/L; under the condition of magnetic stirring, adding 109.3 mg of cetyl trimethyl ammonium bromide (CTAB) into aqueous solution of nickel nitrate according to the molar ratio of surfactant to nickel ion which is 15:1, stirring to aid dissolving;

(2) taking absolute ethanol as solvent to make 10 mL of 1×10⁻² mol/L sodium borohydride reducing solution;

(3) at normal temperature and under the condition of magnetic stirring, rapidly adding 6.0 mL portions of sodium borohydride reducing solution into ethanol solution of nickel nitrate according to the molar ratio of reducing agent to nickel ion, which is 3:1; allow to react for 30 min, then sealing with plastic wrap, at room temperature to aging for 24 h, diluting to 27 mL with deionized water;

(4) adding 34.0 mg of chloroauric acid into 10 mL of deionized water to obtain 1×10⁻² mol/L aqueous solution of chloroauric acid, then adding 3 mL portions of obtained 1×⁻² mol/L aqueous solution of chloroauric acid into 27 mL portions of nickel nano-collosol to make 1×10⁻³ mol/L of chloroauric acid in nickel nano-collosol, stirring for 40 min;

(5) taking deionized water as solvent to make 1×10⁻¹ mol/L aqueous solution of ascorbic acid, then rapidly adding 1.8 mL portions of aqueous solution of ascorbic acid into the mixed solution obtained in step (4) according to the molar ratio of reducing agent to gold ion which is 8:1, stirring and allow to react for 60 min;

(6) allow the reaction solution obtained in step (5) to stand in the magnetic field for 3 h, discarding the supernatant then redispersing the obtained precipitate in deionized water to obtain desired Ni@Au nanoparticle.

### EXAMPLE 5

(1) Taking glycol as solvent, nickel nitrate as solute to make 100.0 mL of glycol solution of nickel nitrate, the concentration of nickel ion in glycol solution of nickel nitrate is 1×10⁻⁴ mol/L; under the condition of magnetic stirring, adding 57.7 mg of sodium dodecyl sulfate (SDS) into glycol solution of nickel nitrate according to the molar ratio of surfactant to nickel ion which is 20:1, stirring to aid dissolving;

(2) taking absolute ethanol as solvent to make 100 mL of 1×10⁻³ mol/L sodium borohydride reducing solution;

(3) at normal temperature and under the condition of magnetic stirring, rapidly adding 40.0 mL portions of sodium borohydride reducing solution into ethanol solution of nickel nitrate according to the molar ratio of reducing agent to nickel ion, which is 4:1; allow to react for 30 min, then sealing with plastic wrap, at room temperature to aging for 24 h, diluting to 198 mL with glycol;

(4) adding 34.0 mg of chloroauric acid into 10 mL of absolute ethanol to obtain 1×10⁻² mol/L ethanol solution of chloroauric acid, then adding 2 mL portions of obtained1×10⁻² mol/L ethanol solution of chloroauric acid into 198 mL portions of nickel nano-collosol to make 1×10⁻⁵ mol/L of chloroauric acid in nickel nano-collosol, stir for 60 min;

(5) taking absolute ethanol as solvent to make 1×10⁻³ mol/L ethanol solution of sodium borohydride, then rapidly adding 8.0 mL portions of ethanol solution of sodium borohydride into the mixed solution obtained in step (4) according to the molar ratio of reducing agent to gold ion which is 4:1, stirring and allow to react for 25 min;

(6) allow the reaction solution obtained in step (5) to stand in the magnetic field for 5 h, discarding the supernatant then redispersing the obtained precipitate in absolute ethanol to obtain desired Ni@Au nanoparticle.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

1. A method for producing core-shell magnetic alloy nanoparticle, comprising:
step 1: dissolving nickel compound in solvent to produce solution, said solution is in the range of 1×10⁻¹ mol/L to 1×10⁻⁴ mol/L;
step 2: adding surfactant into the solution obtained from step 1, the molar ratio of surfactant to nickel ion is in the range of 0.3:1 to 20:1;
step 3: dissolving the first reducing agent in solvent to produce the first reducing solution;
step 4: pipetting the first reducing solution obtained from step 3 according to the molar ratio of the first reducing agent to nickel ion, which is in the range of 2.5:1 to 4:1, and adding into the solution obtained from step 2 with stirring, continue to stir and react for 5 to 30 min, then aging for 3 to 24 h to obtain nickel nano-collosol;
step 5: adding metallic compound into the nickel nano-collosol obtained from step 4 to make the concentration of metallic compound in nickel nano-collosol in the range of 1×10⁻² mol/L to 1×10⁻⁵ mol/L, stirring at room temperature for 20 to 60 min;
step 6: dissolving the second reducing agent in solvent to produce the second reducing solution;
step 7: pipetting the second reducing solution obtained from step 6 according to the molar ratio of the second reducing agent to metallic compound obtained from step 5, which is in the range of 2:1 to 8:1, and adding into the mixed solution obtained from step 5;
step 8, allow the reaction product obtained from step 7 to stand, then discarding the supernatant, redispersing the obtained precipitate in water or absolute ethanol to obtain the core-shell magnetic alloy nanoparticle using nickel as the core.

2. The method for producing core-shell magnetic alloy nanoparticle according to claim 1, wherein in said step 1, said nickel compound is nickel chloride, nickel nitrate or nickel sulfate; said solvent is water, ethanol or glycol.

3. The method for producing core-shell magnetic alloy nanoparticle according to claim 1, wherein in said step 2, said surfactant is sodium citrate, polyvinylpyrrolidone, cetyl trimethyl ammonium bromide or sodium dodecyl sulfate.

4. The method for producing core-shell magnetic alloy nanoparticle according to claim 1, wherein in said step 3, said the first reducing agent is potassium borohydride or sodium borohydride; said solvent is water or ethyl alcohol, the concentration of the first reducing agent is in the range of 5×10⁻¹ mol/L to 1×10⁻³ mol/L.

5. The method for producing core-shell magnetic alloy nanoparticle according to claim 1, wherein in said step 4, aging is carried out at room temperature and in a sealed condition.

6. The method for producing core-shell magnetic alloy nanoparticle according to claim 1, wherein in said step 5, said metallic compound is silver nitrate, chloroauric acid, palladium chloride or chloroplatinic acid.

7. The method for producing core-shell magnetic alloy nanoparticle according to claim 1, wherein in said step 6, said the second reducing agent is ascorbic acid, potassium borohydride or sodium borohydride; said solvent is water or ethanol, the concentrate of the second reducing agent is in the range of 1×10⁻¹ mol/L to 1×10⁻³ mol/L.

8. The method for producing core-shell magnetic alloy nanoparticle according to claim 1, wherein in said step 7, during the process of adding the second reducing solution into the mixed solution obtained from step 5, magnetically stirring the mixed solution obtained from step 5; after adding the second reducing solution into the mixed solution obtained from step 5, continue to stir and react for 5 to 60 min.

9. The method for producing core-shell magnetic alloy nanoparticle according to claim 1, wherein in said step 8, allow the reaction product obtained from step 7 to stand in the magnetic field for 0.5 to 5 h.
